(19) United States
(12) Patent Application Publication
(10) Pub. No.: US 2026/0044370 A1
(43) Pub. Date: Feb. 12, 2026

(54) SYSTEM AND METHOD FOR REAL-TIME DATA ORCHESTRATION AND NATURAL LANGUAGE PROCESSING IN A DISTRIBUTED NETWORK

(71) Applicant: Phani Rohitha Kaza, Monroe, WA (US)

(72) Inventor: Phani Rohitha Kaza, Monroe, WA (US)

(21) Appl. No.: 19/359,151

(22) Filed: Oct. 15, 2025

(51) Int. Cl. G06F 9/48; G06F 16/334; G06F 16/36; G06F 18/21; G06F 40/30; G06N 3/092

(52) U.S. Cl. CPC G06F 9/4881; G06F 16/3344; G06F 16/367; G06F 18/2178; G06F 40/30; G06N 3/092

(57) ABSTRACT

A system and method for real-time data orchestration and natural language processing in a distributed network. The method includes discovering, by an orchestration engine, a plurality of data sources in the distributed network. The method includes receiving, at the orchestration engine, one or more data streams from the plurality data sources. The method includes generating a unified data representation from the received one or more data streams. The method includes determining contextual meaning and one or more inter-node dependencies. The method includes orchestrating execution workflows across the plurality of data sources. The method includes updating, the unified data representation and the execution workflows in response to changes in at least one of one or more network conditions, a computational load, or contextual semantics.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention relates generally to distributed computing and Artificial Intelligence. More particularly, to systems and methods for real-time data orchestration and superintelligent Natural Language Processing (NLP) in distributed networks.

### BACKGROUND OF THE INVENTION

Conventional distributed network systems provide mechanisms for collecting and transmitting data from one or more nodes, such as edge devices, Internet of Things (IoT) sensors, and cloud servers. Frameworks for data integration, such as enterprise data buses or publish-subscribe middleware, allow data exchange between distributed components. However, the Conventional distributed network systems are largely rule-based, relying on static configurations and lacking the adaptability needed for real-time, heterogeneous data environments.

In parallel, Natural Language Processing (NLP) technologies have evolved significantly, with deep learning architectures such as Recurrent Neural Networks (RNNs), transformers, and large language models are utilized for tasks including machine translation, question answering, and text summarization. While these models achieve high accuracy in centralized settings, deployment in distributed and latency-sensitive environments remains limited. Existing systems generally process textual input in isolated pipelines without dynamic orchestration of contextual data originating from distributed sources.

Some existing solutions attempt to address distributed data processing by integrating stream processing engines or cloud-based NLP services. However, the aforementioned approaches suffer from drawbacks such as increased network latency, inability to leverage edge resources efficiently, and lack of semantic interoperability across diverse data modalities. Consequently, existing techniques fall short in providing intelligent, real-time orchestration of distributed data streams combined with advanced NLP capabilities.

Therefore, there is need to develop a system and method to overcome aforementioned problems.

### SUMMARY OF THE INVENTION

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a method for real-time data orchestration and natural language processing in a distributed network is disclosed. The method includes discovering, by an orchestration engine, a plurality of data sources in the distributed network. The method includes receiving, at the orchestration engine, one or more data streams from the plurality data sources. The one or more data streams comprises at least one of structured data, unstructured data, or natural language input. The method includes generating, by the orchestration engine, a unified data representation from the received one or more data streams by performing adaptive metadata mapping and semantic correlation. The method includes determining, by a natural language processing engine associated with the orchestration engine, contextual meaning and one or more inter-node dependencies based on the generated unified data representation. The method includes orchestrating, based on the determined contextual meaning and the one or more inter-node dependencies, execution workflows across the plurality of data sources. Upon orchestrating, the method includes updating, the unified data representation and the execution workflows in response to changes in at least one of one or more network conditions, a computational load, or contextual semantics.

In an embodiment, the term one or more network conditions may refer to a set of measurable parameters that characterize the performance, stability, and quality of data communication links between cloud servers, distributed processing units, and the IoT devices within a hybrid computing environment. The one or more network conditions may be dynamically monitored to determine the feasibility, cost, and timing of data transmission or task migration between nodes. The computational load may refer to the quantitative measure of processing demand or utilization level of a computing entity, such as a distributed processing unit or a cloud server, at a given time. The computational load may reflect the system's current processing capacity and influences decisions related to task allocation, workload balancing, and performance optimization.

In an embodiment, the contextual semantics may refer to the semantic interpretation and situational relevance of data elements derived from associated context, such as time, location, device type, or operational conditions. Unlike raw data attributes, contextual semantics capture the meaning and relationships of data within a specific environment, enabling intelligent analysis and adaptive decision-making.

In accordance with another embodiment of the present disclosure, a system for real-time data orchestration and natural language processing in a distributed network is disclosed. The system includes at least one processor and at least one memory storing instructions that, when executed by the at least one processor, cause the at least one processor to implement an orchestration engine configured to discover a plurality of data sources in the distributed network. The at least one processor is configured to receive one or more data streams from the plurality of data sources, wherein the one or more data streams comprise at least one of structured data, unstructured data, or natural language input. The at least one processor is configured to generate a unified data representation from the received one or more data streams by performing adaptive metadata mapping and semantic correlation. The at least one processor is configured to implement a natural language processing engine, operatively associated with the orchestration engine, configured to determine contextual meaning and one or more inter-node dependencies based on the generated unified data representation. The orchestration engine is further configured to orchestrate, based on the determined contextual meaning and the one or more inter-node dependencies, execution workflows across the plurality of data sources. The orchestration engine is further configured to update the unified data representation and the execution workflows in response to changes in at least one of one or more network conditions, a computational load, or contextual semantics.

In accordance with another embodiment of the present disclosure, a non-transitory computer-readable medium storing instructions that, when executed, cause a processor to discover, using an orchestration engine, a plurality of data sources in the distributed network. The processor is configured to receive, at the orchestration engine, one or more data streams from the plurality data sources, wherein the one or more data streams comprises at least one of structured data, unstructured data, or natural language input. The processor is configured to generate, using the orchestration engine, a unified data representation from the received one or more data streams by performing adaptive metadata mapping and semantic correlation. The processor is configured to determine, using a natural language processing engine associated with the orchestration engine, contextual meaning and one or more inter-node dependencies based on the generated unified data representation. The processor is configured to orchestrate, based on the determined contextual meaning and the one or more inter-node dependencies, execution workflows across the plurality of data sources. Upon orchestrating, the processor is configured to update, the unified data representation and the execution workflows in response to changes in at least one of one or more network conditions, a computational load, or contextual semantics.

One or more advantages of the prior art are overcome, and additional advantages are provided through the invention. Additional features are realized through the technique of the invention. Other embodiments and aspects of the disclosure are described in detail herein and are considered a part of the invention.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a block diagram depicting an exemplary environment of real-time data orchestration and natural language processing in a distributed network, in accordance with an embodiment of the present disclosure;

FIG. 2 is a block diagram depicting the system for real-time data orchestration and natural language processing in the distributed network, in accordance with an embodiment of the present disclosure; and

FIG. 3 is a process flow diagram illustrating a method for method for real-time data orchestration and natural language processing in the distributed network, in accordance with an embodiment of the present disclosure.

Skilled artisans will appreciate the elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

The present invention analyzes, interprets, and manages contextual information for coordinated execution across cloud, edge, and Internet-of-Things (IoT) environments.

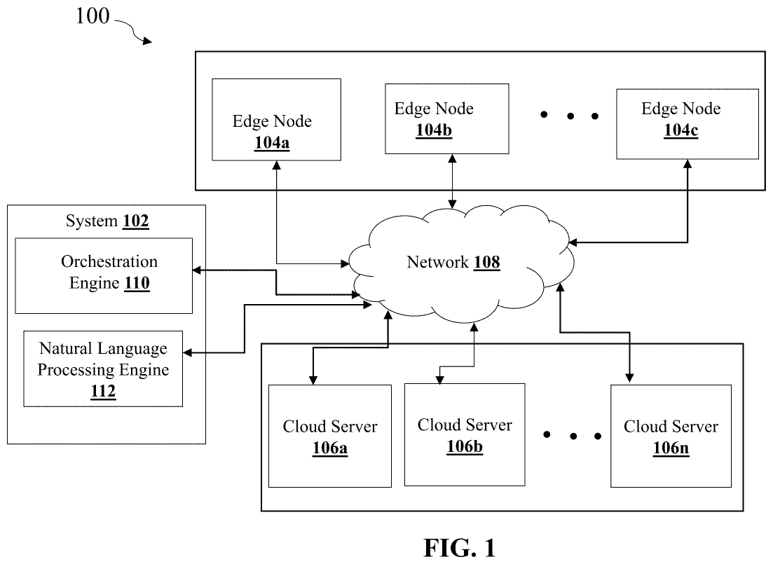

An environment and various implementations for orchestrating data streams in real time within distributed networks, and to the integration of advanced natural language processing (NLP) engines. The environment and processes may be described with reference to FIG. 1 showing an architectural level schematic of a system in accordance with an implementation. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the environment will be described in greater detail.

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

The present disclosure pertains to deployment of advanced natural language processing (NLP) models, including superintelligent NLP engines, configured to process data streams, optimize communication between distributed nodes, and enable intelligent decision-making across interconnected environments such as cloud, edge, and Internet of Things (IoT) ecosystems.

FIG. 1 is a block diagram depicting an exemplary environment 100 of real-time data orchestration and natural language processing in a distributed network, in accordance with an embodiment of the present disclosure. The distributed network may refer to a computing environment including one or more edge nodes 104a, 104b . . . 104n that are geographically or logically separated and are configured to exchange one or more data streams over communication links. In an embodiment, the distributed network may include one or more cloud servers 106a, 106b . . . 106n, Internet-of-Things (IoT) devices, user terminals, and intermediary gateways, each capable of generating, transmitting, or processing the one or more data streams. In an embodiment, the one or more data streams may include, but are not limited to, structured data, unstructured data, natural language input, and the like.

In an embodiment, the distributed network may enable real-time data orchestration by an orchestration engine 110 and facilitate the operation of a natural language processing engine 112 for determining contextual meaning and inter-node dependencies across a plurality of data sources.

According to FIG. 1, the exemplary environment 100 includes a system 102, the one or more edge nodes 104a, 104b, 104c . . . 104n, one or more cloud servers 106a, 106b . . . 106n, and a network 108. The network 108 may include an internet. The network 108 may be rapidly emerging as a preferred system for distributing and exchanging data. The network 108 may include a cellular network, a public land mobile network (PLMN), a second generation (2G) network, a third generation (3G) network, a fourth generation (4G) network (e.g., a long-term evolution (LTE) network), a fifth generation (5G) network, and/or another network. Additionally, or alternatively, the network 108 may include a wide area network (WAN), a metropolitan network (MAN), a telephone network (e.g., the Public Switched Telephone Network (PSTN)), an ad hoc network, an intranet, an Internet, a fiber optic-based network, and/or a combination of these or other types of networks.

In an embodiment, the system 102 may be externally connected to the each of the one or more edge nodes 104a, 104b, 104c . . . 104n through the network 108. In another embodiment, some part of the system 102 may be implemented within the one or more edge nodes 104a, 104b, 104c . . . 104n and remaining part of the system 102 may be externally connected to the one or more edge nodes 104a, 104b, 104c . . . 104n.

The one or more edge nodes 104a, 104b, 104c . . . 104n may include, but are not limited to, one or more Graphical Processing Units (GPUs), one or more Central Processing Units (CPU), one or more Tensor Processing Units (TPUs), and the like. The one or more edge nodes 104a, 104b, 104c . . . 104n may be geographically distributed across a plurality of data centers. The one or more edge nodes 104a, 104b, 104c . . . 104n may be represented as interconnected servers or virtual machines.

In an embodiment, the orchestration engine 110 may indicate a software- and/or hardware-implemented module executable by at least one processor and stored in at least one memory, configured to manage and coordinate the plurality of data sources. The orchestration engine 110 may be configured to perform the plurality of data sources, receive structured, unstructured, and natural language inputs, and generate a unified data representation by applying adaptive metadata mapping and semantic correlation techniques. The plurality of data sources may include, but is not limited to, structured data sources, unstructured data sources, natural language input sources, networked entities, and the like.

The unified data representation may indicate a standardized, semantically consistent, and machine-interpretable data format that enables seamless integration, processing, and exchange of heterogeneous data originating from the one or more edge nodes 104a, 104b, 104c . . . 104n, sensors, and distributed processing environments.

The unified data representation abstracts differences in data structure, encoding, communication protocols, and contextual semantics, thereby allowing AI-driven optimization and orchestration modules to operate on a coherent and interoperable data framework across cloud and distributed processing units.

In an embodiment, the structured data sources may include, but are not limited to, relational databases, transactional systems, or sensor devices generating numerical readings. The unstructured data sources may include, but are not limited to, text documents, multimedia streams, logs, social media feeds, and the like. The natural language input sources may include, but are not limited to, user terminals, chat interfaces, voice-enabled devices, and the like. The networked entities may include, but are not limited to, cloud servers, edge computing nodes, Internet-of-Things (IoT) devices, gateways, and the like.

In an embodiment, the orchestration engine 110 may be configured to execute real-time orchestration of execution workflows across the one or more cloud servers 106a, 106b . . . 106n and the one or more edge nodes 104a, 104b . . . 104n. In an embodiment, the orchestration engine 110 may be configured to dynamically modify the unified data representation and the execution workflows in response to variations in network conditions, computational load, or contextual semantics. The execution workflows may refer to structured, ordered sequences of computational tasks, data exchanges, and control operations that are executed collaboratively across the one or more cloud servers 106a, 106b . . . 106n and distributed processing units to achieve intelligent, real-time data processing and decision-making.

In an embodiment, the execution workflow defines what tasks are to be executed, in what order, on which computing entities, and under what coordination or dependency conditions, thereby enabling synchronized and adaptive processing within the cloud-edge collaborative architecture.

In an embodiment, the NLP engine 112 may indicate to a software and/or hardware-implemented module operatively associated with the orchestration engine 112, executable by the at least one processor and stored in the at least one memory. The NLP engine 112 may be configured to analyze the unified data representation generated by the orchestration engine and determine contextual meaning, semantic intent, and inter-node dependencies across the distributed network. The NLP engine 112 may be configured to employ one or more large-scale language models, transformer-based architectures, or reinforcement learning mechanisms to process natural language inputs and correlate them with other multimodal data streams. The NLP engine 112 may be configured to provide semantic and contextual information to the orchestration engine 110, thereby enabling the execution workflows to be aligned with the determined contextual meaning and inter-node dependencies.

The contextual meaning may refer to the semantic interpretation and situational relevance of data, derived from associated metadata, environmental parameters, temporal features, and operational context within a cloud-edge collaborative environment. Further, the contextual meaning of data enables the system 102 to understand what the data represents, why it is generated, and how it relates to other data or computational tasks, thereby allowing the optimization engine 110 to make informed decisions on task allocation, priority handling, and resource optimization. For example, in a smart grid, a voltage fluctuation recorded by a sensor has a different contextual meaning depending on whether it occurs during peak load hours (interpreted as overload) or maintenance mode (interpreted as a controlled variation). Further, in a smart manufacturing plant, identical vibration data may indicate “normal operation” for one machine but “bearing failure” for another, depending on contextual metadata such as machine type, speed, and prior events.

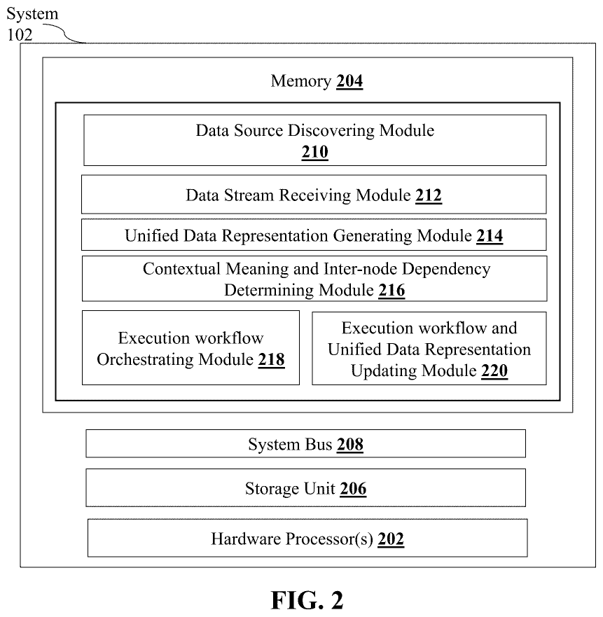

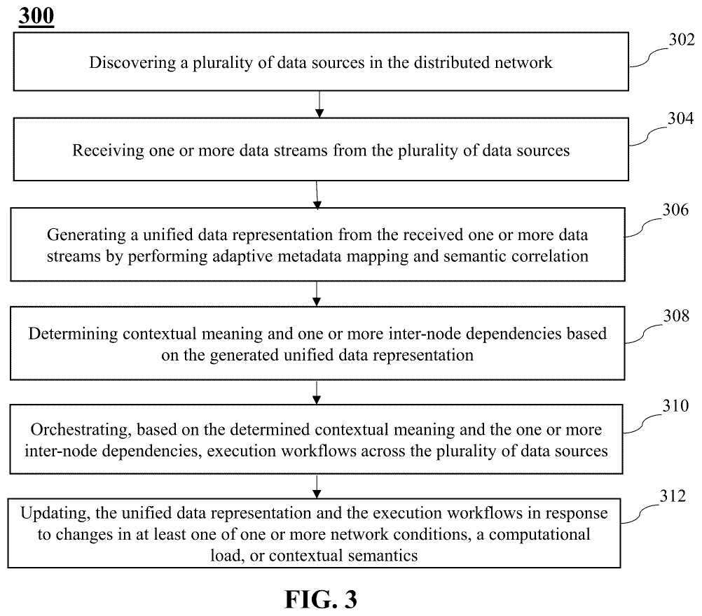

The term inter-node dependencies may refer to the logical, computational, and data-related relationships between two or more distributed processing entities (nodes) participating in a collaborative execution workflow. The inter-node dependencies define how the execution of a particular task on one node influences or relies on data, results, or control signals generated by another node. The system 102 has been further detailed with reference to FIG. 2 and FIG. 3.

FIG. 2 is a block diagram 200 depicting the system 102 for real-time data orchestration and natural language processing in the distributed network, in accordance with an embodiment of the present disclosure. According to FIG. 2, the system 102 may include one or more hardware processors 202, a memory 204 and a storage unit 206. The one or more hardware processors 202, the memory 204 and the storage unit 206 may be communicatively coupled through a system bus 208 or any similar mechanism. The memory 204 may include the adaptive optimization engine 108 in the form of programmable instructions executable by the one or more hardware processors 202. Further, the system 102 may include a data source discovering module 210, a data stream receiving module 212, a unified data representation generating module 214, a contextual meaning and inter-node dependency determining module 216, an execution workflow orchestrating module 218, and an execution workflow and unified data representation updating module 220.

In an embodiment, a module may refer to a functional unit that may be implemented in hardware, software, firmware, or any combination thereof. The module may include one or more processors, memory elements, circuits, logic components, or executable instructions stored on a non-transitory computer-readable medium, which when executed by the at least one processor perform a specified function. The module may be embodied as a standalone component or integrated with other modules within a computing device, the one or more cloud servers 106a, 106b . . . 106n, or the one or more edge nodes 104a, 104b . . . 104n.

In an embodiment, the data source discovering module 210 may be configured to discover the plurality of data sources in the distributed network. The discovery may be performed through endpoint crawling, service registry queries, or network protocol interrogation to detect data-generating entities such as the one or more cloud servers 106a, 106b . . . 106n, the one or more edge nodes 104a, 104b . . . 104n, or IoT devices (not shown). For example, in an industrial IoT environment, the data source discovering module 210 may be configured to identify a temperature sensor, a vibration monitoring system, and a cloud-hosted analytics platform, and register the temperature sensor, the vibration monitoring system, and the cloud-hosted analytics platform as accessible data sources for subsequent orchestration.

Further, the data stream receiving module 212 may be configured to receive one or more data streams from the plurality data sources. The one or more data streams may include, but are not limited to, at least one of structured data, unstructured data, or natural language input. In an embodiment, the data stream receiving module 212 may be configured to establish communication with the plurality data sources and acquire one or more data streams in real time. The one or more data streams may include structured sensor readings, unstructured log data, or natural language commands from user interfaces. For instance, in a smart healthcare environment, the data stream receiving module 212 may be configured to simultaneously acquire numerical heart-rate values from a wearable device, textual doctor's notes from an electronic health record system, and spoken patient feedback converted into text via a voice recognition interface.

In an embodiment, the unified data representation generating module 214 may be configured to generate the unified data representation from the received one or more data streams by performing adaptive metadata mapping and semantic correlation. The semantic correlation may include correlating the one or more data streams with one or more contextual metadata tags to establish semantic relationships between the plurality of data sources.

The unified data representation generating module 214 may be configured to apply ontology-based mapping, schema alignment, and the semantic correlation to integrate data of different modalities. For example, in a logistics management scenario, shipment tracking numbers (structured), customer complaints (unstructured text), and voice-based delivery instructions (natural language) may be converted into a single unified representation, enabling coherent processing.

Further, the contextual meaning and inter-node dependency determining module 216 may be configured to determine contextual meaning and one or more inter-node dependencies based on the generated unified data representation. The contextual meaning and inter-node dependency determining module 216 may be configured to analyze the unified data representation using natural language processing techniques and determine semantic intent as well as dependencies among the one or more edge nodes 104a, 104b . . . 104n. For example, in a distributed financial system, the e contextual meaning and inter-node dependency determining module 216 may be configured to process unified data comprising transaction logs, regulatory updates, and user queries, and determine that a specific transaction node is dependent on real-time compliance validation, thereby establishing a contextual relationship for orchestration.

In an embodiment, the execution workflow orchestrating module 218 may be configured to orchestrate execution workflows across the plurality of data sources based on the determined contextual meaning and the one or more inter-node dependencies. Further, the execution workflow orchestrating module 218 may be configured to coordinate task execution across the plurality of data sources based on the contextual meaning and inter-node dependencies determined.

The execution workflow orchestrating module 218 may be configured to dynamically assign workloads, prioritize data flows, and trigger computation at the one or more edge nodes 104a, 104b . . . 104n. For instance, in an autonomous vehicle network, the execution workflow orchestrating module 218 may be configured to assign the one or more edge nodes 104a, 104b . . . 104n to process sensor fusion tasks locally, while delegating traffic pattern predictions to a cloud-based engine, thereby ensuring coordinated execution across the one or more edge nodes 104a, 104b . . . 104n.

Upon orchestrating, the execution workflow and unified data representation updating module 220 may be configured to update the unified data representation and the execution workflows in response to changes in at least one of one or more network conditions, a computational load, or contextual semantics.

In an embodiment, the execution workflow and unified data representation updating module 220 may be configured to modify the execution workflows and data representations in response to dynamic changes in the distributed network. The changes may include variations in network latency, computational load, or semantic context. For example, in a disaster response network, when communication bandwidth between field sensors and a central server is reduced, the execution workflow and unified data representation updating module 220 may reconfigure the execution workflows to shift critical data processing to nearby the one or more edge nodes 104a, 104b . . . 104n and update the unified data representation accordingly to reflect only high-priority data.

FIG. 3 is a process flow diagram illustrating a method 300 for method for real-time data orchestration and natural language processing in the distributed network, in accordance with an embodiment of the present disclosure.

At step 302, the method 300 may include discovering, by the orchestration engine 110, the plurality of data sources in the distributed network.

At step 304, the method 300 may include receiving, at the orchestration engine 110, the one or more data streams from the plurality data sources. The one or more data streams may include, but are not limited to, the structured data, the unstructured data, the natural language input, and the like.

At step 306, the method 300 may include generating, by the orchestration engine 110, the unified data representation from the received one or more data streams by performing adaptive metadata mapping and the semantic correlation.

At step 308, the method 300 may include determining, by the natural language processing engine 112 associated with the orchestration engine 110, contextual meaning and one or more inter-node dependencies based on the generated unified data representation.

At step 310, the method 300 may include orchestrating, based on the determined contextual meaning and the one or more inter-node dependencies, execution workflows across the plurality of data sources.

Upon orchestrating, at step 312, the method 300 may include updating, the unified data representation and the execution workflows in response to changes the one or more network conditions, the computational load, or the contextual semantics.

In an aspect of the present disclosure, for generating the unified data representation, the method 300 may include applying, by the orchestration engine 110, ontology-based mapping onto heterogeneous data schemas of the received one or more data streams. Further, the method 300 may include aligning, by the orchestration engine 110, the plurality of data sources based on the applied ontology-based mapping. The method 300 may include generating, by the orchestration engine 110, the unified data representation from the received one or more data streams.

In an aspect of the present disclosure, for determining the contextual meaning, the method 300 may include applying, by the orchestration engine 110, a transformer-based natural language processing model based on the generated unified data representation. The transformer-based natural language processing model may be trained on one or more distributed network-specific datasets. Further, the method 300 may include determining, by the natural language processing engine 112 associated with the orchestration engine 110, the contextual meaning based on the applied transformer-based natural language processing model.

In an aspect of the present disclosure, the method 300 may include employing reinforcement learning based on feedback received from the execution workflows across the plurality of data sources.

In an aspect of the present disclosure, for orchestrating the execution workflows, the method 300 may include dynamically allocating one or more tasks between the one or more edge nodes 104a, 104b . . . 104n and the one or more cloud servers 106a, 106b . . . 106n based on computational load metrics. Further, the method 300 may include orchestrating the execution workflows across the plurality of data sources based on the allocated one or more tasks.

In an aspect of the present disclosure, for updating the unified data representation, the method 300 may include updating semantic correlations in response to changes in real-time network topology.

In an aspect of the present disclosure, for updating the unified data representation, the method 300 may include reconfiguring one or more task assignments based on variations in network latency or bandwidth conditions. The method 300 updating, the unified data representation and the execution workflows in response to reconfiguring the one or more task assignments.

In an aspect of the present disclosure, the method 300 may include predicting one or more future network states using historical orchestration patterns. Further, the method 300 may include pre-emptively adjusting the execution workflows based on the predicted one or more future network states.

The methods may be implemented in any suitable hardware, software, firmware, or combination thereof.

Thus, various embodiments of the present invention provide the various technical advantages below:
The present invention allows information from many different sources such as sensors, cloud servers, and user devices to be combined into a single, understandable format in real time.
The present invention uses advanced language technology so the system can understand the context of information and how different parts of the network depend on each other.
The present invention works smoothly across cloud, edge, and IoT devices, without needing everything to be stored in one central place.
The present invention automatically adjusts when network speed, processing power, or the meaning of data changes, so the system keeps working reliably.
The invention can handle different types of data at the same time, including numbers, documents, images, and natural language commands.
The present invention uses smart mapping, The present invention helps different systems and data formats work together without extra manual effort.
The present invention reduces delays by shifting tasks to the right part of the network, for example, closer to the data source when speed is important, or to the cloud when heavy computation is needed.
The present invention makes the network more intelligent and capable of making automatic decisions without constant human setup.
The invention allows orchestration and natural language processing to be performed in a federated manner across nodes, reducing dependency on centralized servers and enhancing resilience.
The present invention handles multiple human languages and correlates language data with other modalities (e.g., sensor signals, video streams), broadening applicability across domains.
The present invention analyzes historical patterns, the system can anticipate future network states and adjust workflows proactively, thereby improving efficiency and continuity of service.
The present invention reconfigures workflows dynamically when nodes fail or communication links are disrupted, ensuring continued operation in critical scenarios.
The present invention automates the alignment of heterogeneous data schemas, lowering manual intervention and system integration costs.
Tasks are not only assigned based on resource availability but also on semantic context, ensuring the most relevant node processes a given task.
The present invention resolves ambiguities in data or natural language input distributed consensus across multiple nodes, improving accuracy in decision-making.
The present invention enables integration with new data sources, protocols, and NLP models without redesigning the system.
The present invention delegates computation intelligently between edge and cloud, the system reduces unnecessary data transfer and lowers power consumption across the network.
With contextual NLP integration, the present invention interprets natural language commands from users in real time and map them into orchestrated workflows, improving usability.
The present invention applies in diverse sectors such as healthcare, finance, logistics, autonomous vehicles, and disaster management, where heterogeneous, distributed data must be processed intelligently.
The present invention maintains semantic awareness of data flows, the present invention identifies sensitive data categories and orchestrate workflows to comply with security or regulatory requirements.

Examples of the techniques and system described herein include, but are not limited to, the following enumerated embodiments:

A method for real-time data orchestration and natural language processing in a distributed network, the method includes,
discovering, by an orchestration engine, a plurality of data sources in the distributed network;
receiving, at the orchestration engine, one or more data streams from the plurality data sources, wherein the one or more data streams comprises at least one of structured data, unstructured data, or natural language input;
generating, by the orchestration engine, a unified data representation from the received one or more data streams by performing adaptive metadata mapping and semantic correlation;
determining, by a natural language processing engine associated with the orchestration engine, contextual meaning and one or more inter-node dependencies based on the generated unified data representation;
orchestrating, based on the determined contextual meaning and the one or more inter-node dependencies, execution workflows across the plurality of data sources; and
upon orchestrating, updating, the unified data representation and the execution workflows in response to changes in at least one of one or more network conditions, a computational load, or contextual semantics.

The method as described in paragraph [062], wherein generating the unified data representation includes,
applying, by the orchestration engine, ontology-based mapping onto data schemas of the received one or more data streams;
aligning, by the orchestration engine, the plurality of data sources based on the applied ontology-based mapping; and
generating, by the orchestration engine, the unified data representation from the received one or more data streams.

The method as described in paragraphs [062]-[063], the semantic correlation includes correlating the one or more data streams with one or more contextual metadata tags to establish semantic relationships between the plurality of data sources.

The method as described in paragraphs [062]-[065], determining the contextual meaning may include,
applying, by the orchestration engine, a transformer-based natural language processing model based on the generated unified data representation, wherein the transformer-based natural language processing model is trained on one or more distributed network-specific datasets; and
determining, by the natural language processing engine associated with the orchestration engine, the contextual meaning based on the applied transformer-based natural language processing model.

The method as described in paragraphs [062]-[065], employing reinforcement learning based on feedback received from the execution workflows across the plurality of data sources.

The method as described in paragraphs [062]-[066], orchestrating the execution workflows may include,
dynamically allocating one or more tasks between one or more edge nodes and one or more cloud servers based on computational load metrics; and
orchestrating the execution workflows across the plurality of data sources based on the allocated one or more tasks.

The method as described in paragraphs [062]-[067], updating the unified data representation may include,
updating semantic correlations in response to changes in real-time network topology.

The method as described in paragraphs [062]-[068], updating the unified data representation may include,
reconfiguring one or more task assignments based on variations in network latency or bandwidth conditions;
updating, the unified data representation and the execution workflows in response to reconfiguring the one or more task assignments.

The method as described in paragraphs [062]-[069], predicting one or more future network states using historical orchestration patterns, and pre-emptively adjusting the execution workflows based on the predicted one or more future network states.

A system for real-time data orchestration and natural language processing in a distributed network, the system includes,
at least one processor;
at least one memory storing instructions that, when executed by the at least one processor, cause the at least one processor to implement an orchestration engine configured to:
discover a plurality of data sources in the distributed network;
receive one or more data streams from the plurality of data sources, wherein the one or more data streams comprise at least one of structured data, unstructured data, or natural language input; and
generate a unified data representation from the received one or more data streams by performing adaptive metadata mapping and semantic correlation;
and further cause the at least one processor to implement a natural language processing engine, operatively associated with the orchestration engine, configured to:
determine contextual meaning and one or more inter-node dependencies based on the generated unified data representation, wherein the orchestration engine is further configured to:
orchestrate, based on the determined contextual meaning and the one or more inter-node dependencies, execution workflows across the plurality of data sources; and
update the unified data representation and the execution workflows in response to changes in at least one of one or more network conditions, a computational load, or contextual semantics.

The system as described in paragraph [71], wherein to generate the unified data representation, the at least one processor is configured to,
apply, using the orchestration engine, ontology-based mapping onto data schemas of the received one or more data streams;
align, using the orchestration engine, the plurality of data sources based on the applied ontology-based mapping; and
generate, using the orchestration engine, the unified data representation from the received one or more data streams.

The system as described in paragraphs [71]-[072], the at least one processor is configured to:
correlate the one or more data streams with one or more contextual metadata tags to establish semantic relationships between the plurality of data sources.

The system as described in paragraphs [071]-[073], to determine the contextual meaning, the at least one processor is configured to:
apply, using the orchestration engine, a transformer-based natural language processing model based on the generated unified data representation, wherein the transformer-based natural language processing model is trained on one or more distributed network-specific datasets; and
determine, using the natural language processing engine associated with the orchestration engine, the contextual meaning based on the applied transformer-based natural language processing model.

The system as described in paragraphs [071]-[074], the at least one processor is configured to:
employ reinforcement learning based on feedback received from the execution workflows across the plurality of data sources.

The system as described in paragraphs [071]-[075], wherein to orchestrate the execution workflows, the at least one processor is configured to:
dynamically allocate one or more tasks between one or more edge nodes and one or more cloud servers based on computational load metrics; and
orchestrate the execution workflows across the plurality of data sources based on the allocated one or more tasks.

The system as described in paragraphs [071]-[076], to update the unified data representation, the at least one processor is configured to:
update semantic correlations in response to changes in real-time network topology.

The system as described in paragraphs [071]-[077], wherein to update the unified data representation the at least one processor is configured to,
reconfigure one or more task assignments based on variations in network latency or bandwidth conditions;
update, the unified data representation and the execution workflows in response to reconfiguring the one or more task assignments.

The system as described in paragraphs [071]-[078], the at least one processor is configured to:
predict one or more future network states using historical orchestration patterns; and
pre-emptively adjust the execution workflows based on the predicted one or more future network states.

A non-transitory computer-readable medium storing instructions that, when executed, cause a processor to,
discover, using an orchestration engine, a plurality of data sources in the distributed network;
receive, at the orchestration engine, one or more data streams from the plurality data sources, wherein the one or more data streams comprises at least one of structured data, unstructured data, or natural language input;
generate, using the orchestration engine, a unified data representation from the received one or more data streams by performing adaptive metadata mapping and semantic correlation;
determine, using a natural language processing engine associated with the orchestration engine, contextual meaning and one or more inter-node dependencies based on the generated unified data representation;
orchestrate, based on the determined contextual meaning and the one or more inter-node dependencies, execution workflows across the plurality of data sources; and
upon orchestrating, update, the unified data representation and the execution workflows in response to changes in at least one of one or more network conditions, a computational load, or contextual semantics.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A method for real-time data orchestration and natural language processing in a distributed network, the method comprising:
discovering, by an orchestration engine, a plurality of data sources in the distributed network;
receiving, at the orchestration engine, one or more data streams from the plurality data sources, wherein the one or more data streams comprises at least one of structured data, unstructured data, or natural language input;
generating, by the orchestration engine, a unified data representation from the received one or more data streams by performing adaptive metadata mapping and semantic correlation;
determining, by a natural language processing engine associated with the orchestration engine, contextual meaning and one or more inter-node dependencies based on the generated unified data representation;
orchestrating, based on the determined contextual meaning and the one or more inter-node dependencies, execution workflows across the plurality of data sources; and
upon orchestrating, updating, the unified data representation and the execution workflows in response to changes in at least one of one or more network conditions, a computational load, or contextual semantics.

2. The method of claim 1, wherein generating the unified data representation comprises:
applying, by the orchestration engine, ontology-based mapping onto data schemas of the received one or more data streams;
aligning, by the orchestration engine, the plurality of data sources based on the applied ontology-based mapping; and
generating, by the orchestration engine, the unified data representation from the received one or more data streams.

3. The method of claim 1, wherein the semantic correlation comprises correlating the one or more data streams with one or more contextual metadata tags to establish semantic relationships between the plurality of data sources.

4. The method of claim 1, wherein determining the contextual meaning comprises:
applying, by the orchestration engine, a transformer-based natural language processing model based on the generated unified data representation, wherein the transformer-based natural language processing model is trained on one or more distributed network-specific datasets; and
determining, by the natural language processing engine associated with the orchestration engine, the contextual meaning based on the applied transformer-based natural language processing model.

5. The method of claim 1, further comprising:
employing reinforcement learning based on feedback received from the execution workflows across the plurality of data sources.

6. The method of claim 1, wherein orchestrating the execution workflows comprises:
dynamically allocating one or more tasks between one or more edge nodes and one or more cloud servers based on computational load metrics; and
orchestrating the execution workflows across the plurality of data sources based on the allocated one or more tasks.

7. The method of claim 1, wherein updating the unified data representation comprises:
updating semantic correlations in response to changes in real-time network topology.

8. The method of claim 1, wherein updating the unified data representation comprises:
reconfiguring one or more task assignments based on variations in network latency or bandwidth conditions;
updating, the unified data representation and the execution workflows in response to reconfiguring the one or more task assignments.

9. The method of claim 1, further comprising:
predicting one or more future network states using historical orchestration patterns; and
pre-emptively adjusting the execution workflows based on the predicted one or more future network states.

10. A system for real-time data orchestration and natural language processing in a distributed network, the system comprising:
at least one processor;
at least one memory storing instructions that, when executed by the at least one processor, cause the at least one processor to implement an orchestration engine configured to:
discover a plurality of data sources in the distributed network;
receive one or more data streams from the plurality of data sources, wherein the one or more data streams comprise at least one of structured data, unstructured data, or natural language input; and
generate a unified data representation from the received one or more data streams by performing adaptive metadata mapping and semantic correlation;
and further cause the at least one processor to implement a natural language processing engine, operatively associated with the orchestration engine, configured to:
determine contextual meaning and one or more inter-node dependencies based on the generated unified data representation, wherein the orchestration engine is further configured to:
orchestrate, based on the determined contextual meaning and the one or more inter-node dependencies, execution workflows across the plurality of data sources; and
update the unified data representation and the execution workflows in response to changes in at least one of one or more network conditions, a computational load, or contextual semantics.

11. The system of claim 10, wherein to generate the unified data representation, the at least one processor is configured:
apply, using the orchestration engine, ontology-based mapping onto data schemas of the received one or more data streams;
align, using the orchestration engine, the plurality of data sources based on the applied ontology-based mapping; and
generate, using the orchestration engine, the unified data representation from the received one or more data streams.

12. The system of claim 10, wherein the at least one processor is configured to:
correlate the one or more data streams with one or more contextual metadata tags to establish semantic relationships between the plurality of data sources.

13. The system of claim 10, wherein to determine the contextual meaning, the at least one processor is configured to:
apply, using the orchestration engine, a transformer-based natural language processing model based on the generated unified data representation, wherein the transformer-based natural language processing model is trained on one or more distributed network-specific datasets; and
determine, using the natural language processing engine associated with the orchestration engine, the contextual meaning based on the applied transformer-based natural language processing model.

14. The system of claim 10, wherein the at least one processor is configured to:
employ reinforcement learning based on feedback received from the execution workflows across the plurality of data sources.

15. The system of claim 10, wherein to orchestrate the execution workflows, the at least one processor is configured to:
dynamically allocate one or more tasks between one or more edge nodes and one or more cloud servers based on computational load metrics; and
orchestrate the execution workflows across the plurality of data sources based on the allocated one or more tasks.

16. The system of claim 10, wherein to update the unified data representation, the at least one processor is configured to:
update semantic correlations in response to changes in real-time network topology.

17. The system of claim 10, wherein to update the unified data representation the at least one processor is configured to:
reconfigure one or more task assignments based on variations in network latency or bandwidth conditions;
update, the unified data representation and the execution workflows in response to reconfiguring the one or more task assignments.

18. The system of claim 10, wherein the at least one processor is configured to:
predict one or more future network states using historical orchestration patterns; and
pre-emptively adjust the execution workflows based on the predicted one or more future network states.

19. A non-transitory computer-readable medium storing instructions that, when executed, cause a processor to:
discover, using an orchestration engine, a plurality of data sources in the distributed network;
receive, at the orchestration engine, one or more data streams from the plurality data sources, wherein the one or more data streams comprises at least one of structured data, unstructured data, or natural language input;
generate, using the orchestration engine, a unified data representation from the received one or more data streams by performing adaptive metadata mapping and semantic correlation;
determine, using a natural language processing engine associated with the orchestration engine, contextual meaning and one or more inter-node dependencies based on the generated unified data representation;
orchestrate, based on the determined contextual meaning and the one or more inter-node dependencies, execution workflows across the plurality of data sources; and
upon orchestrating, update, the unified data representation and the execution workflows in response to changes in at least one of one or more network conditions, a computational load, or contextual semantics.
